(19) United States
(12) Patent Application Publication
(10) Pub. No.: US 2012/0179518 A1
(43) Pub. Date: Jul. 12, 2012

(54) SYSTEM AND METHOD FOR INTERSECTION MONITORING

(76) Inventor: Joshua Timothy Jaipaul, Markham (CA)

(21) Appl. No.: 13/210,521

(22) Filed: Aug. 16, 2011

Related U.S. Application Data
(60) Provisional application No. 61/430,313, filed on Jan. 6, 2011.

(51) Int. Cl. G08G 1/00; G06Q 30/00

(52) U.S. Cl. 705/14.4; 701/117

(57) ABSTRACT

A system and method for monitoring traffic at an intersection of a first street and a second street. The system comprises a camera configured to capture data to represent a view of the second street; and a display screen in communication with the camera for receiving the data, the display screen configured to display the data to drivers on the first street.

### CROSS REFERENCE TO RELATED APPLICATION

This application claims priority to U.S. Provisional Application No. 61/430,313 filed Jan. 6, 2011 and incorporated herein by reference in its entirety.

### FIELD

The present matter is directed to monitoring intersections and particular to monitoring intersections adjacent to an obstruction that can inhibit a driver's view of oncoming traffic.

### BACKGROUND

When drivers or pedestrians approach an intersection they typically look along the intersecting street to see if other vehicles are approaching in order to avoid an accident. For example, drivers normally check the intersection before they pass through it or before they turn onto the intersecting street.

Often there are obstructions on or near the intersecting corner which prevents the drivers from seeing if any traffic is approaching along the intersecting street. For example, a building or parked truck could be blocking or inhibiting a driver's view of the approaching traffic. Commonly, in such situations the driver of the vehicle has to slowly nudge out into the intersection until they can get a better view of any traffic on the intersecting streets. This can lead to accidents or increased traffic congestion.

### SUMMARY

According to an aspect of the present invention, disclosed is a system for monitoring traffic at an intersection of a first street and a second street, the system comprising: a camera configured to capture data to represent a view of the second street; and, a display screen in communication with the camera for receiving the data, the display screen configured to display the data to drivers on the first street.

According to another aspect of the present invention, disclosed is a method for monitoring traffic at an intersection of a first street and a second street, the method comprising: capturing data to represent a view of the second street; transmitting the data to a display screen; and displaying the data on an interface of the display screen to drivers on the first street.

### BRIEF DESCRIPTION OF THE DRAWINGS

In order that the subject matter may be readily understood, embodiments are illustrated by way of examples in the accompanying drawings, in which:

FIG. 1 is a schematic diagram of an embodiment of a system for monitoring traffic;

FIG. 2 shows a top view of an embodiment of an intersection comprising a system for monitoring traffic;

FIG. 3 shows a side elevation view of an embodiment of a display screen;

FIG. 4 is a schematic diagram of an embodiment of a system for monitoring traffic;

FIG. 5 shows a top view of an intersection comprising an embodiment of system for monitoring traffic;

FIG. 6 shows a side elevation view of an embodiment of a display screen with a display counter;

FIG. 7 is a flow chart of an embodiment of a method of monitoring traffic at an intersection; and

FIG. 8 is a flow chart of an embodiment of a method of monitoring traffic at an intersection.

For convenience like numerals in the description refer to like structures in the drawings.

### DETAILED DESCRIPTION

Disclosed is a system for monitoring traffic at an intersection. A camera captures data on a second street and transmits the data to be displayed on a display screen to drivers or pedestrians on a first street. The captured data shows traffic (if any) on the second street that would otherwise be at least partially obstructed by view to drivers or pedestrians on the first street. The obstruction could be caused a building, a truck or another vehicle adjacent the intersection, for example.

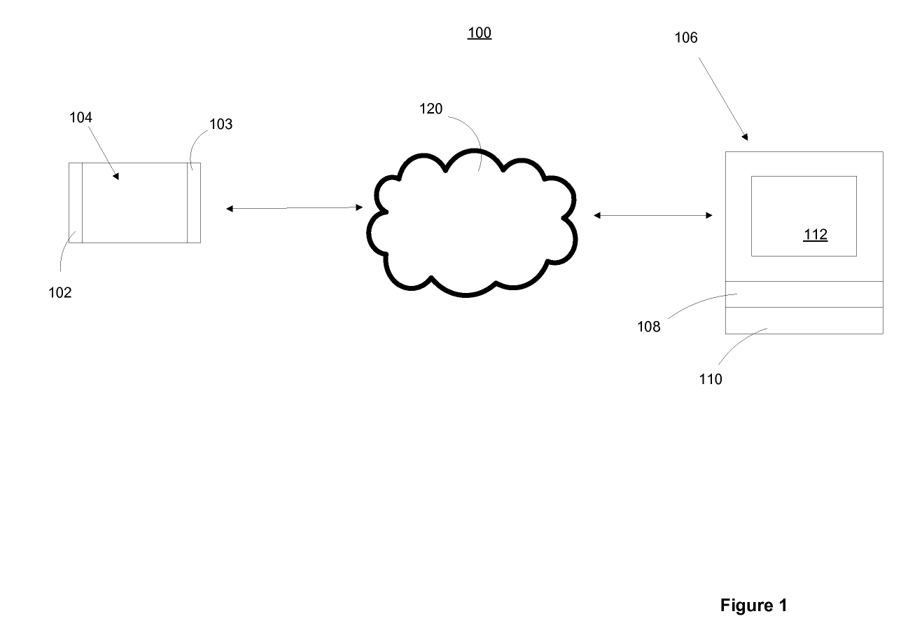

FIG. 1 is a schematic diagram of an embodiment of a system 100 for monitoring traffic. A video camera 104 is connected over a network 120 to a display screen 106. The network 120 can be a LAN, WAN or the Internet, for example. By way of further example, the network 120 can be a wired connected between the video camera 104 and the display screen 106. The video camera 104 comprises a lens 102 and a storage 103. The display screen 106 comprises a processor 108 and memory 110 as well a display interface 112. The memory 110 can store instructions that are executable by the processor 108, for example.

The camera 104 can capture or detect data comprising images through the lens 102 and record or store the data on the storage 103. The storage 103 can be a removable storage medium (e.g. digital storage, video tape, etc.) or can be an internal memory integral with the camera 104.

The data can be transmitted from the camera 104 over the network 120 to the display screen 106. Data received at the display screen 106 can be displayed, played or shown on the interface 112. The data can be displayed in real-time on the display screen 106. For example, when the camera 104 captures the data through the lens 102, the camera 104 simultaneously, or shortly thereafter, transmits the data over the network 120 to the display screen 106, where it is displayed on the interface 112. Alternatively, or additionally, data received at the display screen 106 can be stored in memory 110.

According to an embodiment, the display screen 106 may also be connected over the network 120 (or an alternative network) to a computer station (not shown). The computer station can be remote from the display screen 106 and can remotely monitor or track or record the data received at the display screen 106. Further, the computer station can transmit additional data to be displayed on the display screen 106. For example, the computer station can transmit advertisements or targeted advertisements to be shown on the display screen 106. The advertisements can be shown along side the displayed data on the display screen 106, for example.

By way of further example, the captured data can comprise periodic photographs taken by the camera 104 and transmitted to the display screen 106 for display. For example, the camera 104 can take a photograph (e.g. a digital photograph) twenty-four times a second and transmit the photograph to the display screen 106 to be immediately displayed. Photographs will thereby be displayed in one-twenty-fourth second intervals on the display screen 106.

According to a further exemplary embodiment, lights are attached on or near the display 106 in order to illuminate the display screen 106. For example, at night time or when visibility may be limited (e.g. during a rainstorm, snowstorm or fog) the lights could be turned on to illuminate the display screen 106 in order to increase the visibility of the display screen 106. The light could be small lights mounted around the periphery of the display screen 106 for example. The lights may be programmable by the processor 108 associated with the display screen 106. For example, the lights can be programmed to turn on at a certain time of day. Further, the lights can be remotely operated, such as over a network by a remote computer station.

According to a further exemplary embodiment, the display screen 106 may be enclosed in a case (not shown). For example, the case may have a transparent window through which the display screen 106 can be viewed. The case provides protection to the display screen 106 and accompanying components (e.g. the processor 108 and memory 110) from elements such as weather conditions. For example, the case can be a weather-proof case. The case can be a removable case that attaches over the display screen 106 by screws, snaps, rivets or other similar attachment mechanisms familiar to skilled persons.

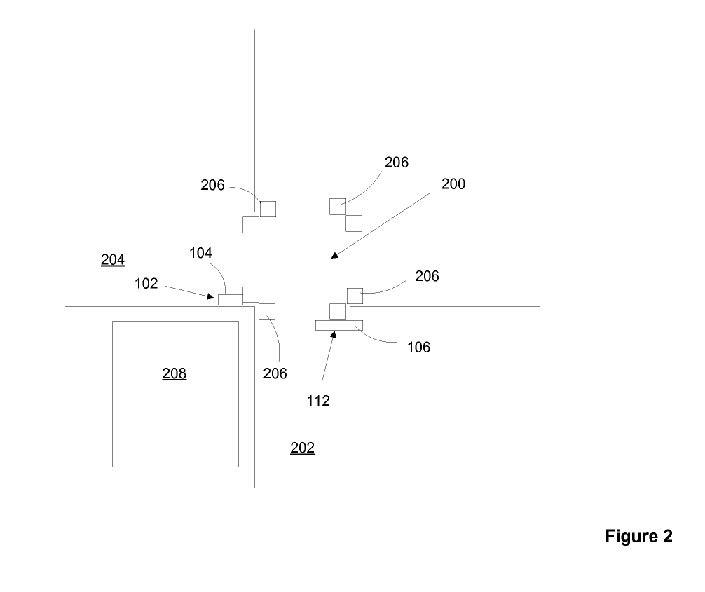

FIG. 2 is a top view of an intersection 200 showing an embodiment of the system for monitoring traffic at the intersection 200. The intersection 200 is a location where a first street 202 and a second street 204 intersect with each other. It is understood that additional streets could meet at the intersection 200 (e.g. a third or fourth street). It is also understood that the first street 202 or second street 204 could end at the intersection 200.

According to the embodiment depicted in FIG. 2, traffic lights 206 are located at the intersection facing each traffic direction. The display screen 106 is mounted adjacent to one set of traffic lights 206. The camera 104 is mounted adjacent to another set of traffic lights. The lens 102 of the camera 104 is directed towards oncoming traffic on the second street 204. The display interface 112 is directed towards oncoming traffic on the first street 202. It is recognized that there may be no traffic lights 206 at the intersection 200. The display screen 106 and camera 104 can be mounted, for example, on a pole (e.g. the respective traffic light 206 pole) or other object.

It is also recognized that there may be additional cameras 104 capturing data on additional streets (not shown) that intersect at the intersection of the first street 202 and the second street 204. These additional cameras 105 transmit captured data to additional display screens 106 or to a single display screen 106. Data received from more than one camera 104 at the display screen 106 can, for example, be displayed on different sections of the display screen 106 or can be periodically displayed on the display screen 106 (e.g. so that the display screen cycles through the data from each street in timed intervals).

A building 208 is located at the corner between the first street 202 and second street 204 between the camera 104 and the display screen 106. The building 208 is one example of an obstruction that can inhibit the view of a portion of the second street 204 from the first street 202. For example, as a driver is heading towards the intersection 200 on the first street 202, the driver's view of the second street 204 may be, at least partially, obstructed by the building 208. Other examples of obstructions that can inhibit a driver's (or pedestrian's) view of the second street 204 (or a portion of the second street 204 near the intersection 200) from the first street 202 include large trucks, other vehicles or fences.

The camera 104 captures data of the second street 204 to be displayed on the display screen 106 to drivers or pedestrians on the first street 202. When displayed on the display screen 106, the data reveals to the drivers or pedestrians what could be an otherwise inhibited view of the second street 204. The view can be inhibited, for example, by an obstruction such as a building or truck or other vehicle.

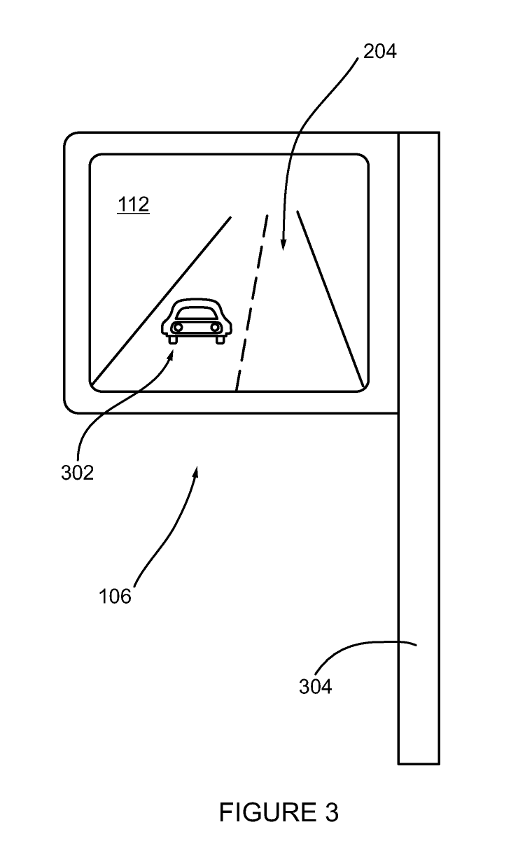

FIG. 3 shows an embodiment of the display screen 106. The display screen 106 is attached to or mounted on a pole 304. The pole 304 can, for example, be a street light pole, traffic light pole, stop sign pole, electrical wire pole or another standalone pole. The view of the interface 112 of the display screen 106 in FIG. 3 shows the second street 204 with a car 302 driving or stopped on the second street 204. Other mechanisms for mounting the display screen 106 (or camera 104) would be familiar to skilled persons.

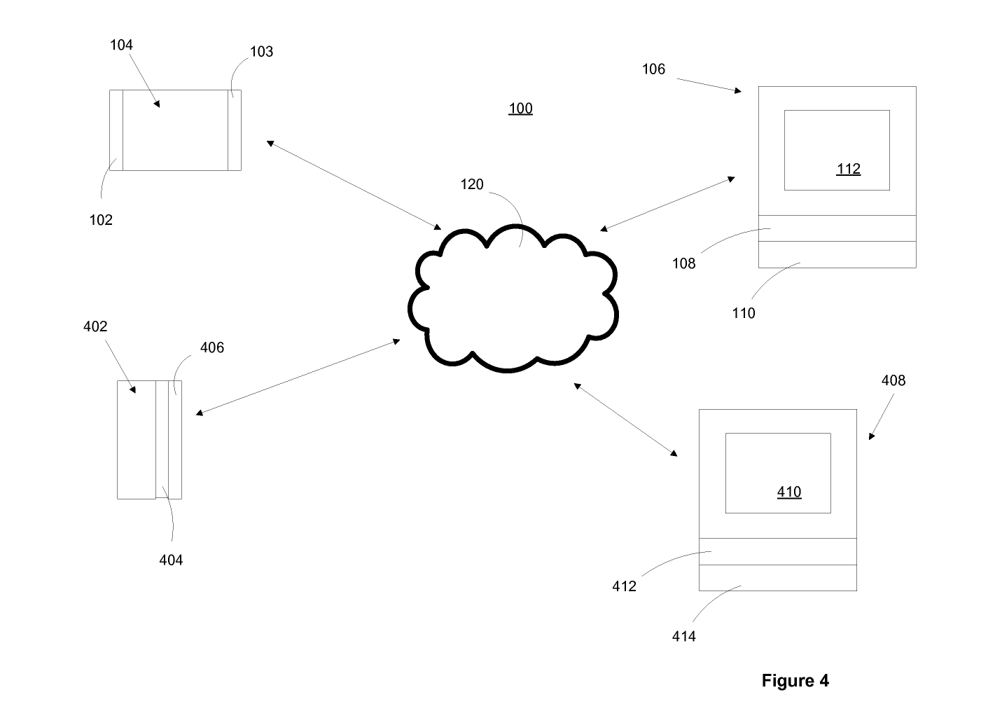

Another embodiment of the system 100 for monitoring traffic at an intersection 200 is shown in the schematic of FIG. 4. A sensor 402 can communicate data over the network 120 to a display counter 408. The sensor 402 can be in communication with the display counter 408 over a hard wire, for example. The sensor 402 has a processor 404 and a memory 406. The display counter 408 comprises a counter interface 410 and can also comprise a processor 412 and memory 414.

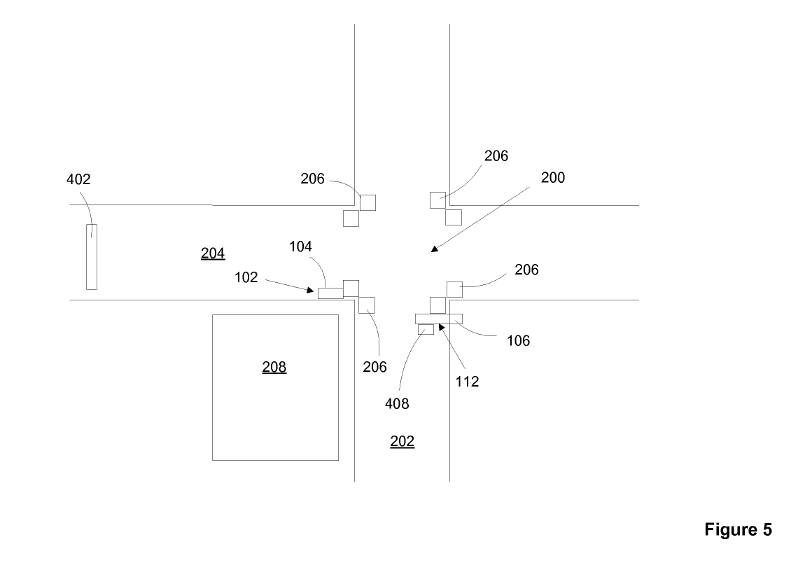

Referring to FIG. 5, the sensor 402 is embedded in the second street 204. The sensor senses at least one measurement of a vehicle passing overhead on the second street 204. The measurements are used by the processor 404 of the sensor 402 to estimate the time of arrival of the vehicle at the intersection 200. For example, the sensor 402 can measure the speed of a vehicle passing overhead. This speed measurement can then be used to estimate the time of arrival of the vehicle at the intersection 200. The sensor 402 can communicate this estimated time of arrival to the display counter 408. By way of further example, the sensor 402 can measure the amount of time that elapses between when the front and back wheels of a vehicle pass over the sensor 402. Using this measured amount of time, the processor 404 of the sensor 402 can calculate an estimated time of arrival of the vehicle at the intersection 200.

In another exemplary embodiment, the sensor 402 could estimate the time of arrival of a vehicle at the intersection 200 using an assumption that the vehicle is travelling at the speed limit between the sensor 402 and the intersection.

In a further exemplary embodiment, the display counter 408 displays an indication of whether it is safe or not to turn into or cross the intersection 200. For example, the display counter 408 displays or flashes a red light when it is not safe to turn into or cross the intersection 200 and displays or flashes a green light when it is safe to turn into or cross the intersection 200. A determination of whether or not it is safe to turn into or cross the intersection 200 is made by the processor 412 associated with the display counter 408 using certain assumptions and calculations, such as the average time it takes a vehicle to cross or turn into the intersection 200 from a stopped position and whether this amount of time is more or less than the amount of time that the sensor 402 estimates it will take before another vehicle reaches the intersection 200. The display counter 408 displays a red light when the processor 412 of the display counter 408 estimates that the average time it takes a vehicle to pass through or turn into the intersection 200 is more than the estimated time of arrival of a vehicle at the intersection 200 from the sensor 402. The display counter 408 displays a green light when the processor 412 of the display counter 408 estimates that the average time it takes a vehicle to pass through or turn into the intersection 200 is less than the estimated time of arrival of a vehicle at the intersection 200 from the sensor 402. The display counter 408 may be configured top display a yellow or amber light in certain situations, such as when the estimated time of arrival of a vehicle at the intersection 200 from the sensor 402 is within two seconds of the average time it takes a vehicle to pass through or turn onto the intersection 200.

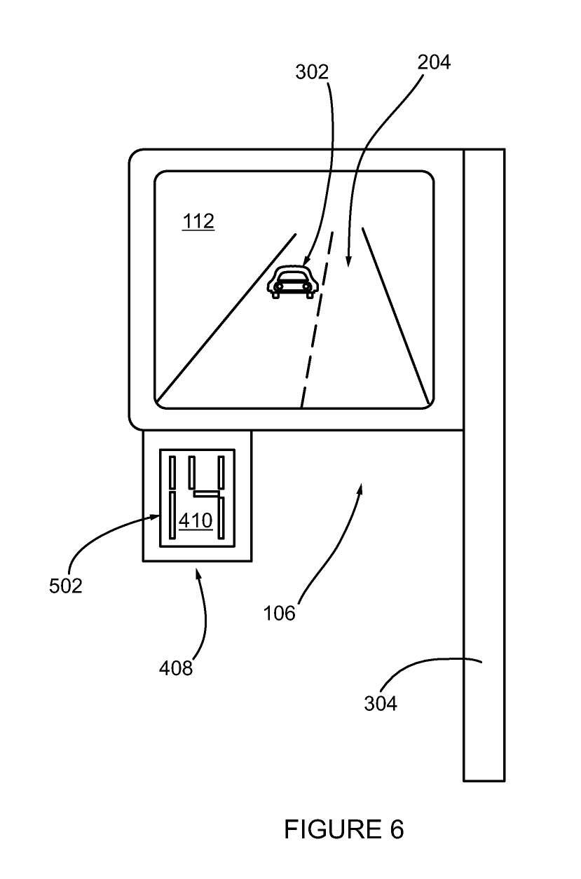

Referring still to the embodiment of FIG. 5, the display counter 408 is configured so that the counter interface 410 can be seen from the first street 202 along with the display screen 106. For example, referring to FIG. 6 and FIG. 4, the display counter 408 can be attached adjacent to the display screen 106. The counter interface 410 of the display counter 408 can show the estimated time of arrival 502 as received from the sensor 402. The processor 412 of the display counter 408 can be configured to count down (e.g. in seconds) from the estimated time of arrival so that the display counter shows a number 502 in second of the estimated time of arrival of the vehicle 302 at the intersection 200. It is understood that the display counter 408 can be mounted directly to the pole 304 or to another structure on the side of the first street 202 or second street 204. The display counter 408 can show advertisements or can be a blank screen when no count down or estimated time of arrival is being displayed on the display counter 408.

According to an exemplary embodiment, advertisements may only be shown on the display counter 408 when there is a red light (i.e. traffic is stopped) or when the display screen 106 is not displaying any live data.

There can be additional sensors 402 (not shown) embedded in the second street 204 for sensing at least one measurement of the vehicle passing overtop. The additional sensor(s) 402 can similarly transmit the at least one measurement or an estimated time of arrival to the display counter 408. This received data (e.g. the transmitted estimated time of arrival) can be used to refine the time being counted down on the display counter 408, for example.

It is recognized that the sensor(s) 402 may be mounted on the side of the road and may comprise, for example, radar devices for measuring the velocity and/or acceleration of the passing vehicles.

In a further embodiment the display counter 408 and hence the counter interface 410 occupies or overlays a portion of the display screen 106. Additionally, the “walk” and “do not walk” signs, familiar to skilled persons, could also occupy a portion of the display screen 106.

### Operation

Described below are methods of monitoring traffic at the intersection 200 of the first street 202 and second street 204 with the intersection 200 having an obstruction 208 adjacent thereto that inhibits the view of a portion of the second street 204 from the first street 202.

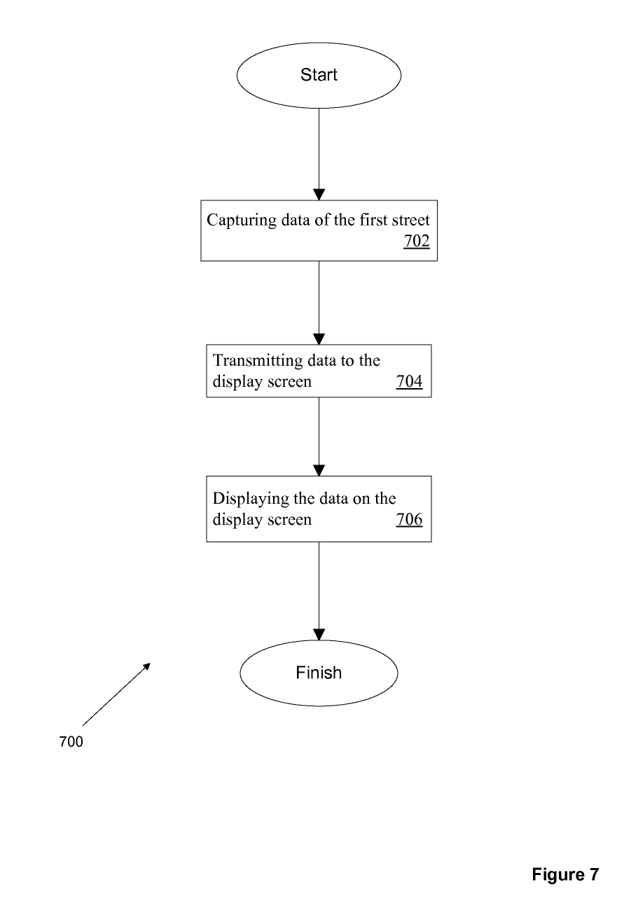

FIG. 7 is a flowchart depicting a method 700 of monitoring traffic at the intersection 200 of the first street 202 and second street 204. At step 702 the camera 104 captures data of the second street 204. The captured data can include traffic on the second street 204 heading towards the intersection 200. This data can optionally be stored in the storage 103 of the camera 104. At step 704 the data is transmitted to the display screen 106. The data can be, optionally, stored in the memory 110 of the display screen 106. Optionally, the data can be transmitted (e.g. over the Internet or other network) to a remote computer station from the camera 104 or from the display screen 106. Similarly, the remote computer station can access the data on the display screen 106 or the camera 104.

At step 706 the data is displayed on the interface 112 of the display screen 106 to drivers on the first street 202. The display screen 106 can be configured so that pedestrians and/or cyclists on the first street 202 can also view the interface 112. The data can reveal to drivers or pedestrians on the first street 202 the otherwise inhibited view of the second street 204. The view can be otherwise inhibited by an obstruction such as a truck, a building or a fence, for example.

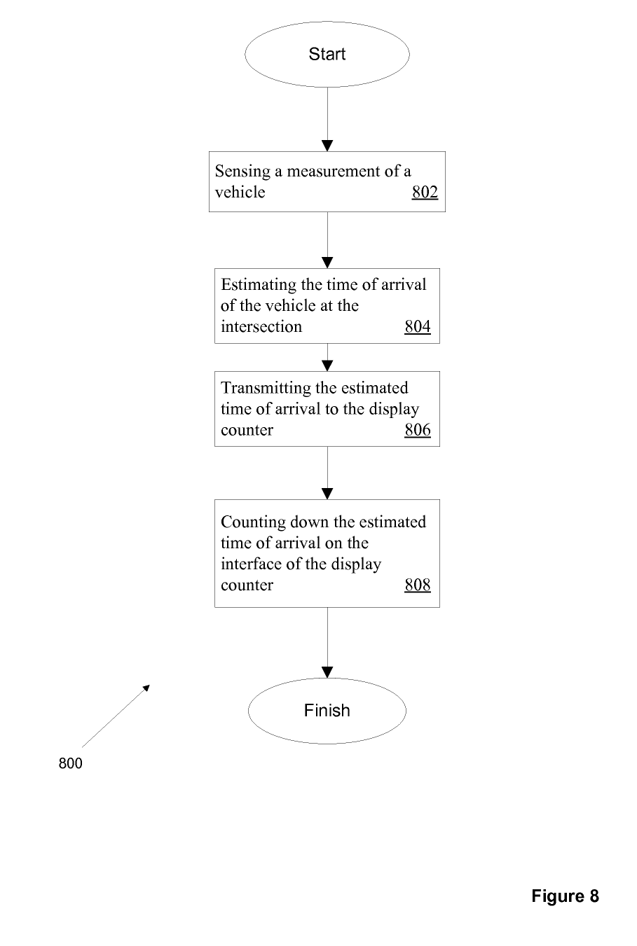

FIG. 8 is a flowchart showing another embodiment of a method 800 of monitoring traffic at the intersection 200 of the first street 202 and the second street 204. At step 802, at least one measurement of a vehicle 302 on the second street 204 is sensed. This sensing is accomplished using one or more sensor(s) 402.

At step 804 the time of arrival of the vehicle 302 at the intersection 200 is estimated using the at least one sensed measurement. For example, the processor 404 associated with the sensor 402 can use the at least one sensed measurements to determine (or estimate) the acceleration and/or velocity and/or weight of the moving vehicle. Using this determination (or estimate) the processor can calculate an estimated time of arrival of the vehicle 302 at the intersection 200.

At step 806 this estimated time of arrival is transmitted to the display counter 408. The display counter 408 can store the received estimated time of arrival in memory 414. Further, the display counter 408 and/or the sensor(s) 402 can transmit the estimated time of arrival (or, in the case of the sensor, the at least one measurement) over a network to the remote computer.

At step 808 the estimated time of arrival is counted down on the interface 410 of the display counter 408. For example, the processor 412 can instruct the interface 410 to display, in seconds, the time remaining 502 from the estimated time of arrival until the estimated time of arrival reaches a minimum threshold of time (e.g. 1 second) or until the estimated time of arrival reaches no time (i.e. 0 seconds).

If a second vehicle passes over the sensor 402 while the display counter 408 is counting down the estimated time of arrival for the initial vehicle, then the sensor 402 will similarly sense the at least one measurement of the second vehicle (step 802), estimate the time of arrival of the second vehicle (step 804) and transmit the estimated time of arrival to the display counter 408 (step 808). The display counter 408 can store the estimated time of arrival of the second vehicle in memory 414 until the estimated time of arrival of the initial vehicle has elapsed, at which time the remaining estimated time of arrival 502 of the second vehicle can be counted down on the display counter 408. The processor 412 can continue to count down the estimated time of arrival of the second vehicle that is stored in memory 414 so that when the second vehicle's estimated time of arrival is displayed or counted down on the display counter 408 it will remain an accurate estimate.

One or more currently preferred embodiments have been described by way of example. It will be apparent to persons skilled in the art that a number of variations and modifications can be made without departing from the scope of the invention as defined in the claims.

What is claimed is the following:

1. A system for monitoring traffic at an intersection of a first street and a second street, the system comprising:
a camera configured to capture data representing a view of the second street; and,
a display screen in communication with the camera for receiving the data, the display screen configured to display the data to drivers on the first street.

2. The system of claim 1 wherein advertisements are displayed on the display screen.

3. The system of claim 1 wherein the camera is mounted to a pole adjacent the second street.

4. The system of claim 1 wherein the display screen is mounted to a pole adjacent the first street.

5. The system of claim 4 wherein the pole is one of the traffic light pole and the stop sign pole.

6. The system of claim 1 wherein the display screen is in wireless communication with the camera over a network for transmitting the data.

7. The system of claim 1 further comprising:
a sensor configured to sense at least one measurement of a vehicle on the second street, the sensor connected to a processor for calculating an estimated time of arrival of the vehicle at the intersection based on the at least one measurement; and
a display counter in communication with the sensor for receiving the estimated time of arrival, the display counter configured to display a count down of the estimated time of arrival to people on the first street.

8. The system of claim 7 wherein the sensor is embedded in the second street.

9. The system of claim 7, the at least one measurement comprising at least one of a velocity and weight of the vehicle passing overtop.

10. The system of claim 7 wherein the sensor comprises a radar device.

11. The system of claim 7 wherein the display counter is in wireless communication with the sensor for receiving the estimated time of arrival.

12. The system of claim 7 wherein the display screen comprises the display counter.

13. A method for monitoring traffic at an intersection of a first street and a second street, the method comprising:
capturing data to represent a view of the second street;
transmitting the data to a display screen; and
displaying the data on an interface of the display screen to drivers on the first street.

14. The method of claim 13 further comprising displaying advertisements on the display screen.

15. The method of claim 13 wherein the sensor is embedded in the second street.

16. The method of claim 13 wherein the sensor is a radar device.

17. The method of claim 13 wherein the display screen is mounted to a pole adjacent the first street.

18. The method of claim 17 wherein the pole is one of the traffic light pole and the stop sign pole.

19. The method of claim 13 wherein the step of transmitted is performed by wireless communication.

20. The method of claim 13 further comprising:
sensing at least one measurement of a vehicle on the second street;
estimating the time of arrival of the vehicle at the intersection using the at least one measurement;
transmitting the estimated time of arrival to a display counter; and
counting down the estimated time of arrival on an interface of the display counter to drivers on the first street.

21. The method of claim 20, the at least one measurement comprising at least one of a velocity and weight of the vehicle passing overtop.

22. The method of claim 20 wherein the step of sensing is performed using an accelerometer.

23. The method of claim 20 wherein the step of transmitting is performed by wireless communication.

24. The method of claim 20 wherein the display screen comprises the display counter.
